(19) United States
(12) Patent Application Publication
(10) Pub. No.: US 2021/0344605 A1
(43) Pub. Date: Nov. 4, 2021

(54) CIRCUITRY WITHIN ROUTER OR SWITCH AND CORRESPONDING FRAME PROCESSING METHOD

(71) Applicant: Realtek Semiconductor Corp., HsinChu (TW)

(72) Inventors: Chung-Keng Hung, HsinChu (TW); Yung-Kun Lin, HsinChu (TW); Chih-Ching Chen, HsinChu (TW); Ta-Chin Tseng, HsinChu (TW)

(21) Appl. No.: 17/117,138

(22) Filed: Dec. 10, 2020

Related U.S. Application Data
(60) Provisional application No. 63/017,663, filed on Apr. 30, 2020.

(51) Int. Cl. H04L 12/851; H04L 12/865

(52) U.S. Cl. CPC H04L 47/2433; H04L 47/6275

(57) ABSTRACT

The present invention provides a circuitry within a router or a switch, wherein the circuitry comprises a priority decision circuitry and a per-stream filtering and policing circuitry. The priority decision circuitry is configured to determine a priority of a frame received from a port of the router or the switch. The per-stream filtering and policing circuitry is configured to classify the frame into a first-type frame, a second-type frame or a third-type frame, wherein if the frame is determined as the first-type frame, the per-stream filtering and policing circuitry forwards the frame; if the frame is determined as the third-type frame, the per-stream filtering and policing circuitry discards the frame; and if the frame is determined as the second-type frame, the per-stream filtering and policing circuitry changes the priority of the frame, and the per-stream filtering and policing circuitry forwards the frame with the changed priority.

### CROSS REFERENCE TO RELATED APPLICATIONS

This application claims the priority of U.S. Provisional Application No. 63/017,663, filed on Apr. 30, 2020, which is included herein by reference in its entirety.

### BACKGROUND OF THE INVENTION

### 1. Field of the Invention

The present invention relates to a per-stream filtering and policing mechanism of a switch or a router.

### 2. Description of the Prior Art

A switch has a priority decision circuit to determine priority of a frame based on information of the frame such as a priority code point (PCP) of a virtual local area network (VLAN) tag, a differentiated services code point (DSCP) of Internet Protocol (IP), port-based configuration etc., and the frame is enqueued based on the priority determined by the priority decision circuit. Then, the frame is selected for transmission based on the priority queue and corresponding algorithm.

IEEE 802.1 Qci standard defines a per-stream filtering and policing mechanism comprising frame filters, stream gates and flow meters, where the frame filter identifies the frame and assigns the stream gate and flow meter for the frame; then the stream gate assigns the frame priority based on common time information of the network; the flow meter classifies the frame as a green frame, a yellow frame or a red frame. Then, the flow meter takes action based on the color of the frame, where the green frame is forwarded to an output port, the red frame is discarded, and the flow meter can be configured to discard the yellow frame or mark a drop eligible indicator (DEI) field of the VLAN tag. In the standard, however, the frame priority is determined based on the time information only, and the flow meter has no flexibility in changing the frame priority. Therefore, if the data rate of the frame temporarily exceeds the committed bandwidth due to network factors or other factors, traffic of the other frame(s) having the same priority may be influenced, and the system will become complicated in frame processing.

### SUMMARY OF THE INVENTION

It is therefore an objective of the present invention to provide a circuitry within a switch, which can change a priority of the frame based on the traffic bandwidth, to solve the above-mentioned problems.

According to one embodiment of the present invention, a circuitry within a router or a switch is disclosed, wherein the circuitry comprises a priority decision circuitry and a per-stream filtering and policing circuitry. The priority decision circuitry is configured to determine a priority of a frame received from a port of the router or the switch. The per-stream filtering and policing circuitry is configured to classify the frame into a first-type frame, a second-type frame or a third-type frame, wherein if the frame is determined as the first-type frame, the per-stream filtering and policing circuitry forwards the frame to a priority to traffic mapping circuitry to enqueue the frame; if the frame is determined as the third-type frame, the per-stream filtering and policing circuitry discards the frame; and if the frame is determined as the second-type frame, the per-stream filtering and policing circuitry changes the priority of the frame, and the per-stream filtering and policing circuitry forwards the frame with the changed priority to the priority to traffic mapping circuitry to enqueue the frame.

According to another embodiment of the present invention, a frame processing method applied to a router or a switch is disclosed. The frame processing method comprises the steps of: determining a priority of a frame received from a port of the router or the switch; classifying the frame into a first-type frame, a second-type frame or a third-type frame; if the frame is determined as the first-type frame, forwarding the frame to enqueue the frame; if the frame is determined as the third-type frame, discarding the frame; and if the frame is determined as the second-type frame, changing the priority of the frame, and forwarding the frame with the changed priority to enqueue the frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 shows the per stream filtering and policing circuitry according to one embodiment of the present invention.

FIG. 3 is a flowchart of the operation of the flow meter according to one embodiment of the present invention.

FIG. 4 shows fields within the VLAN tag.

### DETAILED DESCRIPTION

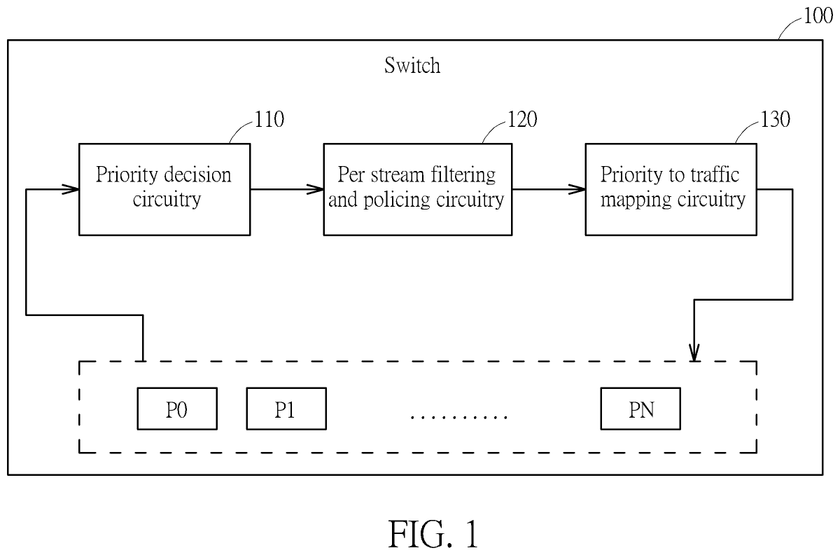

FIG. 1 is a diagram illustrating an electronic device according to one embodiment of the present invention, wherein the electronic device may be a switch or a router, and the switch 100 is used as an example in the following description. As shown in FIG. 1, the switch 100 comprises a plurality of ports P0-PN, a priority decision circuitry 110, a per stream filtering and policing circuitry 120 and a priority to traffic mapping circuitry 130, wherein each of the ports P0-PN is used to connect to an external electronic device via an Ethernet cable, and the external electronic device can communicate with another electronic device via the switch 100.

In the operation of the switch 100, when at least a portion of the ports P0-PN receive frames from external electronic device(s), the priority decision circuitry 110 determines priority of each frame, the per stream filtering and policing circuitry 120 classifies the frames to determine if forwarding the frame(s) or discarding the frame(s), wherein the priority of the frame(s) may be modified according to the bandwidth of the stream/traffic. The priority to traffic mapping circuitry 130 forwards each frame to the corresponding destination port, wherein the transmission order of the frame is determined based on its own priority and/or the priority of the other frames. Specifically, the priority decision circuitry 110 determines the priority of each frame based on the internal information carried in a header of the frame, for example, the priority is determined based on a prior-based priority source, an inner-tag-based priority source, an outer-tag-based priority source, a hybrid-based priority source and a DSCP-based priority source. Because the priority arbitration within the priority decision circuitry 110 is well known by a person skilled in the art, the detailed description is omitted here.

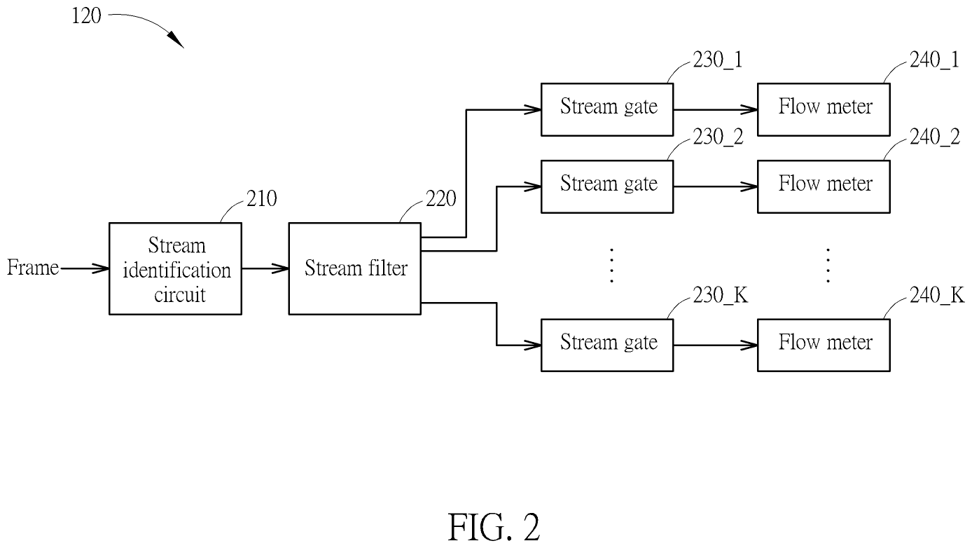

After the priority of each frame is determined, the per stream filtering and policing circuitry 120 receives the frames and their priority information. FIG. 2 shows the per stream filtering and policing circuitry 120 according to one embodiment of the present invention, where the per stream filtering and policing circuitry 120 comprises a stream identification circuit 210, a stream filter 220, a plurality of stream gates 230_1-230_K, and a plurality of flow meters 240_1-240_K. During the operation of the per stream filtering and policing circuitry 120, the stream identification circuit 210 maps the frames to streams. In detail, the stream identification circuit 210 has a table, each entry of the table may comprise a matching rule, port list and a stream handle indicator, and the matching rule may be a universal set from standards such as a destination address and a source address from a data link layer (layer 2), a destination IP and a source IP from a network layer (layer 3) and a transmission control protocol (TCP)/user datagram protocol (UDP) port. The stream identification circuit 210 can compare the frame content with the table to map the frames to the streams. The stream filter 220 filters the frames to discard some inappropriate frames (size or content does not meet the rule), and the stream filter 220 sends the allowed frames to the corresponding stream gate. In detail, the stream filter 220 has a table, each entry of the table comprises a stream handle indicator, priority of the frame, corresponding stream gate, corresponding flow meter and a max service data unit (SDU) size. The stream filter 220 can compare the frame content with the table to determine the rules to apply for the stream(s). Each of the stream gates 230_1-230_K is periodically opened to allow the stream to pass, and the stream may be discarded or blocked when the stream gate is closed. In addition, each of the stream gates 230_1-230_K may set an internal priority value (IPV) to the stream/frame for designating the traffic class without modifying the frame content.

Because the present invention focuses on the operation of the flow meters 240_1-240_K, and the operations of the stream identification circuit 210, the stream filter 220 and the plurality of stream gates 230_1-230_K are well known by a person skilled in the art, the detailed descriptions about the stream identification circuit 210, the stream filter 220 and the plurality of stream gates 230_1-230_K are omitted here.

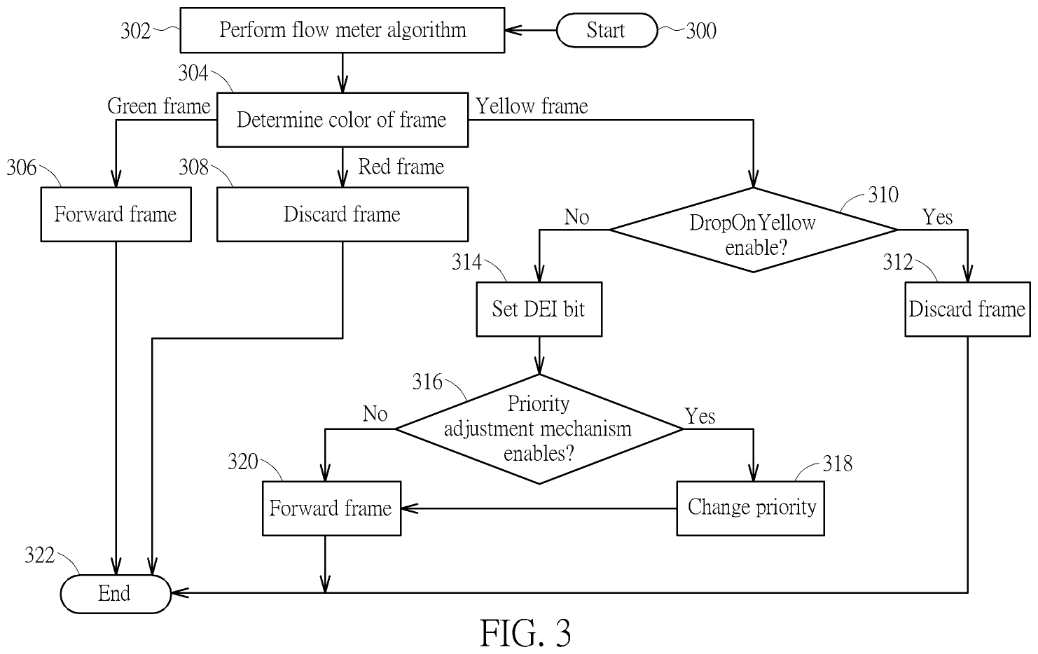

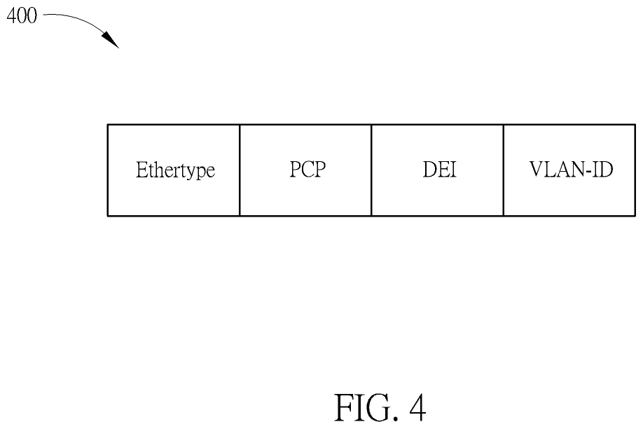

FIG. 3 is a flowchart of the operation of the flow meter according to one embodiment of the present invention, where the flow meter 240_1 is an example used in the following description. In Step 300, the flow starts, and a DEI bit of the VLAN tag (which can be inner VLAN or outer VLAN) is obtained from the frame, and the DEI bit is set to have an initial value. FIG. 4 shows the VLAN tag 400, wherein the VLAN tag has an Ether-type field, a PCP field, a DEI field and a VLAN-ID (VLAN identity). In Step 302, the flow meter 240_1 executes a flow meter algorithm to classify the frame based on the bandwidth profile of the switch 100. For example, the flow meter algorithm may be complied with a technical specification of ‘MEF 10.3’. In Step 304, the flow meter algorithm is executed, and the frame can be determined as a first-type frame, a second-type frame or a third-type frame, wherein the first-type frame is named as a green frame indicating the bandwidth is lower than a committed bandwidth (e.g. a first threshold such as 10 Mbps), the second-type frame is named as a yellow frame indicating the bandwidth is higher than the committed bandwidth (e.g. 10 Mbps) but lower than a second threshold (e.g. 15 Mbps), and the third-type frame is named as a red frame indicating the bandwidth is higher than the second threshold (e.g. 15 Mbps).

After the frame is classified in Step 304, if the frame is determined as the green frame, the flow enters Step 306; if the frame is determined as the red frame, the flow enters Step 308; and if the frame is determined as the yellow frame, the flow enters Step 310. In Step 306, the frame is sent to the priority to traffic mapping circuitry 130, and after the frame is enqueued based on the priority, the frame is sent to the destination port. In Step 308, the frame is discarded. In Step 310, it is determined is a parameter indicating that the yellow frame is discarded. In this embodiment, this parameter is a parameter ‘DropOnYellow’ in the IEEE 802.1 Qci standard, and the parameter can be set by a user for controlling the traffic of the switch 100. If the parameter is enabled, the flow enters Step 312; and if the parameter is disabled, the flow enters Step 314.

In Step 312, the frame is discarded. In Step 314, the DEI bit is set to indicate that the frame is not dropped or discarded in the presence of congestion. In Step 316, it is determined if a priority adjustment mechanism is enabled by setting a parameter, if yes, the flow enters Step 318; and if not, the flow enters Step 320. In Step 318, the flow meter 240_1 changes the priority of the yellow frame, for example, the flow meter 240_1 lowers the IPV of the yellow frame. In Step 320, the frame is enqueued based on the priority (or the changed priority), then the frame is sent to the destination port via the operation of the priority to traffic mapping circuitry 130.

In the embodiment shown in FIG. 3, by using the Step 316 and Step 318 to change the priority of the yellow frame, the traffics of the switch 100 is less likely to cause frame processing problems due to instantaneous bandwidth congestion. For example, assuming that two streams are processed in the switch 100, a first stream has a plurality of first frames whose bandwidth is 10 Mbps, a second stream has a plurality of second frames whose bandwidth is 10 Mbps, and the first frames and the second frames have the same priority determined in the priority decision circuitry 110, once the first stream has the network issue and the bandwidth instantly rises to 15 Mbps, the rear frames in the first stream are determined as the yellow frames with lower priority. Therefore, because the rear frames (yellow frame) having the lower priority are transmitted later, the original frames in the first stream and the second stream can be sent with the normal speed without dealing with the network issue.

In addition, if the Step 316 and Step 318 are not used, the first frames and the second frames are transmitted based on the original priority (i.e. the same priority same) even if the first stream has the network issue and the bandwidth instantly rises, and the traffics of the second stream will be influenced and the frame processing becomes complicated.

Briefly summarized, in the circuitry within the switch of the present invention, when the current bandwidth is higher than the committed bandwidth, the frames entering the flow meter is controlled to lower the priority so that the other frames can be transmitted smoothly at the original rate. Therefore, the system will not become complicated in frame processing while suffering the bandwidth congestion issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuitry within a router or a switch, comprising:
a priority decision circuitry, configured to determine a priority of a frame received from a port of the router or the switch;
a per-stream filtering and policing circuitry, coupled to the priority decision circuitry, configured to classify the frame into a first-type frame, a second-type frame or a third-type frame, wherein if the frame is determined as the first-type frame, the per-stream filtering and policing circuitry forwards the frame to a priority to traffic mapping circuitry to enqueue the frame; if the frame is determined as the third-type frame, the per-stream filtering and policing circuitry discards the frame; and if the frame is determined as the second-type frame, the per-stream filtering and policing circuitry changes the priority of the frame, and the per-stream filtering and policing circuitry forwards the frame with the changed priority to the priority to traffic mapping circuitry to enqueue the frame.

2. The circuitry of claim 1, wherein the per-stream filtering and policing circuitry classifies the frame into the first-type frame, the second-type frame or the second type-frame according to the current bandwidth of stream(s); and if the frame is determined as the second-type frame, the per-stream filtering and policing circuitry changes the priority of the frame.

3. The circuitry of claim 2, wherein if the current bandwidth of the stream(s) is lower than a first threshold, the per-stream filtering and policing circuitry determines the frame as the first-type frame; if the current bandwidth of the stream(s) is higher than the first threshold but lower than a second threshold, the per-stream filtering and policing circuitry determines the frame as the second-type frame; and if the current bandwidth of the stream(s) is higher than the second threshold, the per-stream filtering and policing circuitry determines the frame as the third-type frame.

4. The circuitry of claim 1, wherein the per-stream filtering and policing circuitry has a parameter configured to enable or disable a priority adjustment mechanism, and when the parameter is set to enable the priority adjustment mechanism, and if the frame is determined as the second-type frame, the per-stream filtering and policing circuitry changes the priority of the frame, and the per-stream filtering and policing circuitry forwards the frame with the changed priority to the priority to traffic mapping circuitry to enqueue the frame; and when the parameter is set to disable the priority adjustment mechanism, and if the frame is determined as the second-type frame, the per-stream filtering and policing circuitry directly forwards the frame without changing the priority to the priority to traffic mapping circuitry to enqueue the frame.

5. The circuitry of claim 1, wherein the per-stream filtering and policing circuitry comprises:
a stream identification circuit, configured to maps the frames to a stream;
a stream filter, couple to the stream identification circuit, configured to forward or discard the frame based on content of the frame;
a stream gate, coupled to the stream filter, configured to receive the frame is the frame is not discarded by the stream filter, and to periodically forward the frame or block the frame; and
a flow meter, configured to classify the frame into the first-type frame, the second-type frame or the second type-frame.
wherein if the frame is determined as the first-type frame, the flow meter forwards the frame to the priority to traffic mapping circuitry to enqueue the frame; if the frame is determined as the third-type frame, the flow meter discards the frame; and if the frame is determined as the second-type frame, the flow meter changes the priority of the frame, and the flow meter forwards the frame with the changed priority to the priority to traffic mapping circuitry to enqueue the frame.

6. The circuitry of claim 5, wherein the stream gate sets an internal priority value for the frame; and if the frame is determined as the second-type frame, the flow meter changes the priority of the frame by changing the internal priority value, and the flow meter forwards the frame with the changed internal priority value to the priority to traffic mapping circuitry to enqueue the frame.

7. A frame processing method applied to a router or a switch, comprising:
determining a priority of a frame received from a port of the router or the switch;
classifying the frame into a first-type frame, a second-type frame or a third-type frame;
if the frame is determined as the first-type frame, forwarding the frame to enqueue the frame;
if the frame is determined as the third-type frame, discarding the frame; and
if the frame is determined as the second-type frame, changing the priority of the frame, and forwarding the frame with the changed priority to enqueue the frame.

8. The frame processing method of claim 7, wherein the step of classifying the frame into the first-type frame, the second-type frame or the third-type frame comprises:
classifying the frame into the first-type frame, the second-type frame or the second type-frame according to the current bandwidth of traffic;
wherein if the frame is determined as the second-type frame, changing the priority of the frame.

9. The frame processing method of claim 8, wherein the step of classifying the frame into the first-type frame, the second-type frame or the second type-frame according to the current bandwidth of the stream(s) comprises:
if the current bandwidth of the stream(s) is lower than a first threshold, determining the frame as the first-type frame;
if the current bandwidth of the stream(s) is higher than the first threshold but lower than a second threshold, determining the frame as the second-type frame; and
if the current bandwidth of the stream(s) is higher than the second threshold, determining the frame as the third-type frame.

10. The frame processing method of claim 7, further comprising:
setting a parameter to enable or disable a priority adjustment mechanism;
when the parameter is set to enable the priority adjustment mechanism, and if the frame is determined as the second-type frame, changing the priority of the frame, and forwarding the frame with the changed priority to enqueue the frame; and
when the parameter is set to disable the priority adjustment mechanism, and if the frame is determined as the second-type frame, forwarding the frame without changing the priority to enqueue the frame.
